(19) United States
(12) Patent Application Publication
(10) Pub. No.: US 2025/0264135 A1
(43) Pub. Date: Aug. 21, 2025

(54) SLIDE THROUGH UNIVERSAL JOINT ASSEMBLY

(71) Applicant: Steering Solutions IP Holding Corporation, Saginaw, MI (US)

(72) Inventors: Michael E. Partyka, Saginaw, MI (US); Bruce D. Kniebbe, Birch Run, MI (US)

(21) Appl. No.: 18/582,197

(22) Filed: Feb. 20, 2024

(51) Int. Cl. F16D 3/20; F16D 3/40

(52) U.S. Cl. CPC F16D 3/20; F16D 3/40

(57) ABSTRACT

A universal joint assembly for a steering shaft assembly includes a first yoke and a second yoke. The universal joint assembly also includes a hollow spider defining a central opening extending from a first end to a second end, wherein the first yoke is operatively coupled to the hollow spider and positioned on the first end of the hollow spider, the second yoke operatively coupled to the hollow spider and positioned on the second end of the hollow spider. The universal joint assembly further includes a slider shaft extending through the first yoke and aligned with the central opening of the hollow spider, wherein the slider shaft is selectively translated through the central opening.

### FIELD OF THE INVENTION

The embodiments disclosed herein relate to vehicle steering systems and, more particularly, a slide through universal joint assembly for use in vehicle steering systems.

### BACKGROUND

Steering systems include a steering shaft assembly which connects a steering input device (e.g., steering wheel) to an output component or assembly to carry out steering maneuvers for a vehicle. The steering shaft assembly typically includes multiple segments which are operatively coupled to each other with various connections. One type of connection is a universal joint which accommodates relative movement of the components being connected along the steering shaft assembly.

Technological advancements associated with vehicle steering systems, particularly in autonomous or semi-autonomously driven vehicles, may require more steering column retraction distance capability to enhance the space available for a driver when compared to traditional steering column retraction distances. Retraction refers to movement of the steering column toward and/or fully into a dashboard. The connecting components, particularly universal joints, hinder the efforts to increase the retraction distance due to their size, shape and geometry. Therefore, improvements to these limitations would be well received in the vehicle steering system industry and by vehicle OEMs.

### SUMMARY

According to one aspect of the disclosure, a universal joint assembly for a steering shaft assembly includes a first yoke and a second yoke. The universal joint assembly also includes a hollow spider defining a central opening extending from a first end to a second end, wherein the first yoke is operatively coupled to the hollow spider and positioned on the first end of the hollow spider, the second yoke operatively coupled to the hollow spider and positioned on the second end of the hollow spider. The universal joint assembly further includes a slider shaft extending through the first yoke and aligned with the central opening of the hollow spider, wherein the slider shaft is selectively translated through the central opening.

According to another aspect of the disclosure, a hollow spider for a universal joint assembly in a steering shaft assembly includes a first side, a second side, a third side and a fourth side. The hollow spider also includes a first axial end and a second axial end. The hollow spider further includes an outer surface. The hollow spider yet further includes an inner surface defining a central opening sized to receive a shaft therethrough.

According to another aspect of the disclosure, a steering shaft assembly for a vehicle steering system includes a first yoke. The steering shaft assembly also includes a first shaft assembly component operatively coupled to the first yoke. The steering shaft assembly further includes a second yoke. The steering shaft assembly yet further includes a second shaft assembly component operatively coupled to the second yoke. The steering shaft assembly also includes a hollow spider defining a central opening extending from a first end to a second end, wherein the first yoke is operatively coupled to the hollow spider and positioned on the first end of the hollow spider, the second yoke operatively coupled to the hollow spider and positioned on the second end of the hollow spider. The first shaft assembly component extends through the first yoke and is aligned with the central opening of the hollow spider, wherein the first shaft assembly component is selectively translated through the central opening.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a vehicle steering system;

FIG. 2 is a perspective, disassembled view of a portion of the vehicle steering system having a slide through universal joint connection components of the vehicle steering system;

FIG. 3 is a perspective view of the portion of the vehicle steering system of FIG. 2 in an assembled condition;

FIG. 4 is an elevation view of the portion of the vehicle steering system of FIGS. 2 and 3 in the assembled condition;

FIG. 5 is a perspective, disassembled view of the portion of the vehicle steering system according to another aspect of the disclosure; and

FIG. 6 is a perspective view of the portion of the vehicle steering system of FIG. 5 in an assembled condition.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

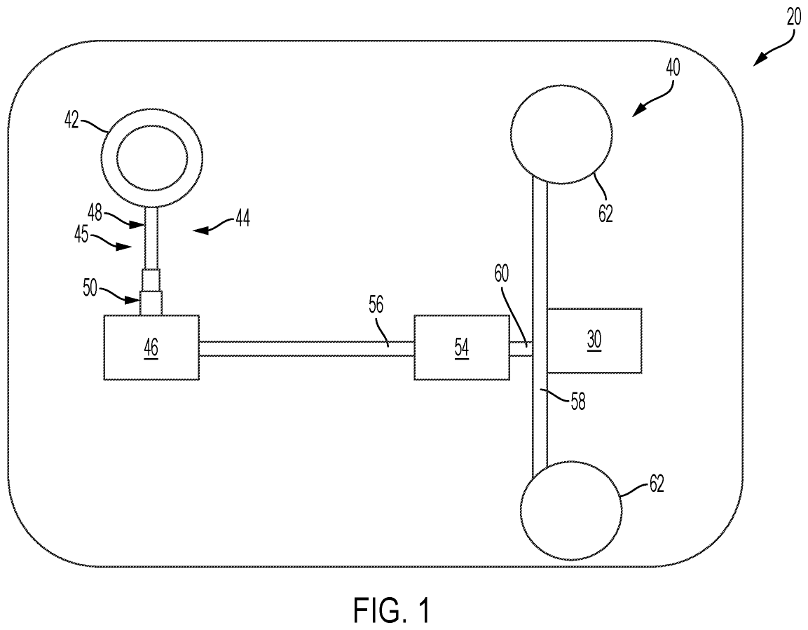

Referring initially to FIG. 1, a vehicle 20 is generally illustrated according to the principles of the present disclosure. The vehicle 20 may include any suitable vehicle, such as a car, a truck, a sport utility vehicle, a mini-van, a crossover, any other passenger vehicle, any suitable commercial vehicle, or any other suitable vehicle. While the vehicle 20 may be a passenger vehicle having wheels and for use on roads, the principles of the present disclosure may apply to other vehicles, such as planes, tractors, boats, or other vehicles. The vehicle 20 may include a propulsion system 30, such as an ignition system, an electronic system, or combinations thereof.

The vehicle 20 further includes a steering system 40. The steering system 40 may be configured as a driver interface steering system, an autonomous driving system, or a system that allows for both driver interface and autonomous steering. The steering system 40 may include an input device 42, such as a steering wheel, wherein a driver may mechanically provide a steering input by turning the steering wheel. A steering column assembly 44 includes a steering column 45 that extends along an axis from the input device 42 to an output assembly 46. The output assembly 46 may include a pinion shaft assembly, an I-shaft, a cardan joint, steer-by-wire components or any feature conventionally located opposite the input device 42.

The steering column 45 includes one or more axially adjustable portions, for example, an upper jacket 48 and a lower jacket 50 that are axially adjustable with respect to one another. It is contemplated that additional jackets are utilized in some embodiments. It is to be appreciated that other structural features of the steering column 45 may be part of the upper jacket 48 and the lower jacket 50, such as brackets, rails, other devices, or combinations thereof.

The steering column 45 is moveable over a range of positions from a fully extended position to a fully retracted position. In the fully extended position, the upper jacket 48 and the lower jacket 50 are moved axially so that the input device 42 is located near an operator of the vehicle. In the retracted position, the upper jacket 48 and the lower jacket 50 are moved axially so that the input device 42 is located further away from an operator of the vehicle, when compared to the extended position. In some embodiments, the retracted position may correspond to stowing the input device 42. For example, it may be beneficial to place the input device 42 in a stowed location during autonomous driving. In operation, the axial movement of the upper jacket 48 and the lower jacket 50 may be effectuated by manual movement by an operator or electromechanically by a telescope or translation actuator. This axial movement adjusts between the extended position, the retracted position, and any intermediary positions.

A steering gear assembly 54, the output assembly 46 and the steering input device 42 may be connected via a steering shaft assembly 56. The steering gear assembly 54 may be configured as a rack-and-pinion, a recirculating ball-type steering gear, or any other types of steering gears associated with autonomous and driver-interface steering systems. The steering gear assembly 54 may then connect to a driving axle 58 via an output shaft 60. The output shaft 60 may include a pitman arm and sector gear and/or various traditional components. The output shaft 60 is operably connected to the steering gear assembly 54 such that a rotation of the steering shaft assembly 56 causes a responsive movement of the output shaft 60 and causes the drive axle to turn wheels 62. It is to be appreciated that the steering components described herein may be part of a steer-by-wire system or one which includes a direct mechanical linkage over the span of the components.

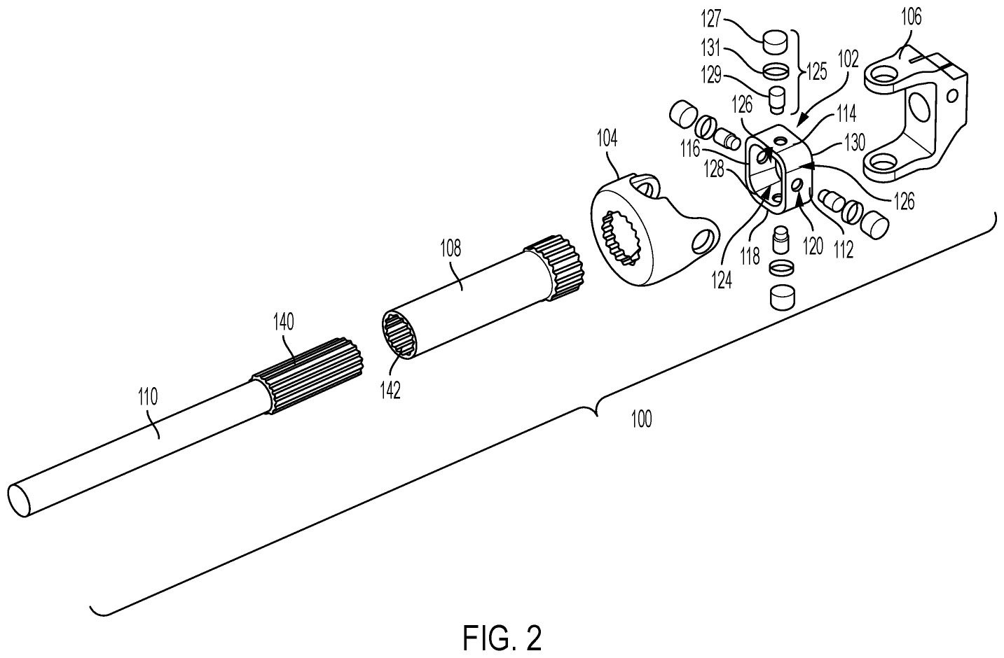

Referring now to FIG. 2, a slide through universal joint assembly 100 according to a first embodiment is illustrated in a disassembled condition. The universal joint assembly 100 includes a hollow spider 102, a first yoke 104, a second yoke 106, a shaft tube 108 and a slider shaft 110. In the illustrated embodiment, the hollow spider 102 is shown to be substantially rectangular with rounded corners. In particular, the hollow spider 102 includes a first side 112, a second side 114, a third side 116 and a fourth side 118. The first side 112 and the third side 116 are on opposite sides of the hollow spider 102 and do not have adjacent corners. The second side 114 and the fourth side 118 are on opposite sides of the hollow spider 102 and do not have adjacent corners. Each side 112, 114, 116, 118 defines a respective hole 120 extending through the side from an outer surface 122 of the hollow spider 102 to an inner surface 124 of the hollow spider 102.

Each of the holes 120 of the hollow spider 102 are sized and positioned to have a portion of a bearing assembly 125 disposed therein and secured to the hollow spider 102. In particular, the bearing assembly 125 includes a bearing 127, a pin 129 and a face seal 131. In some embodiments, the face seal 131 may not be required depending upon the application of use. Regardless of whether the face seal is included, the pin 129 is press fit—or otherwise secured-into the hole 120 of the hollow spider 102 during assembly and the bearing 127 is pressed into a hole defined by one of the yokes 104, 106 and onto the pin 129. Each of the four bearing assemblies 125 are assembled within the overall assembly in the above-described manner.

While the hollow spider 102 is illustrated as substantially rectangular, it is to be understood that other general shapes are contemplated and are within the scope of this disclosure. By way of non-limiting example, a circular spider may be employed.

Regardless of the particular general shape of the hollow spider 102, the hollow spider 102 defines a central opening 126 defined by the inner surface 124 of the hollow spider 102 and extends completely through the hollow spider 102 from a first end 128 to a second end 130 of the hollow spider 102.

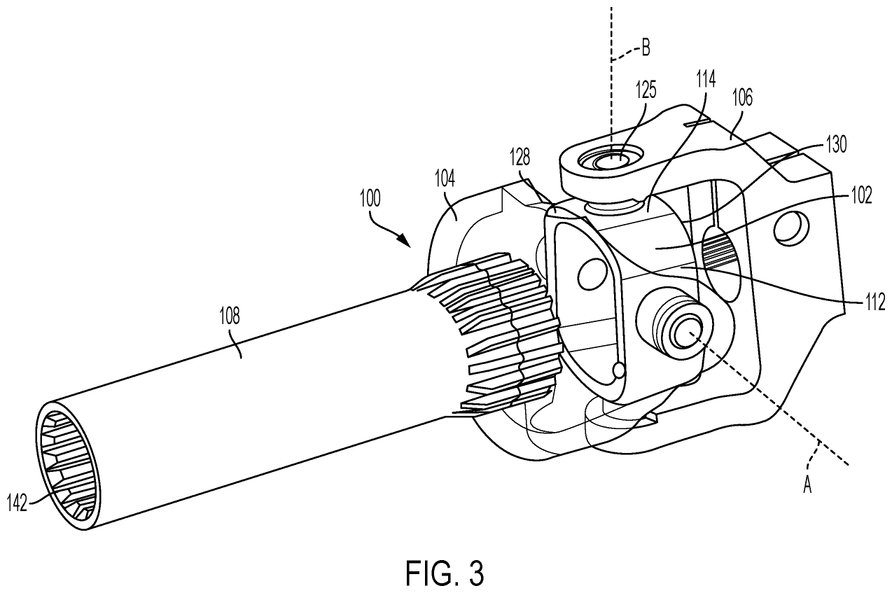

Referring now to FIG. 3, the slide through universal joint assembly 100 is shown in an assembled condition. The universal joint assembly 100 is utilized to connect two components while allowing for rotational motion of each component about different axes. In particular, the first yoke 104 is connected to the hollow spider 102 via the bearing assemblies 125 disposed in the holes 120 defined by first side 112 and the third side 116 of the hollow spider 102. This allows the first yoke 104 to be positioned on the first end 128 of the hollow spider 102 and pivot about a first axis A. The second yoke 106 is connected to the hollow spider 102 via the bearing assemblies 125 disposed in the holes 120 defined by second side 114 and the fourth side 118 of the hollow spider 102. This allows the second yoke 106 to be positioned on the second end 130 of the hollow spider 102 and pivot about a second axis B. In the illustrated embodiment, the first axis A and the second axis B are oriented approximately perpendicular to each other.

Each of the first yoke 104 and the second yoke 106 are operatively coupled to, or integrally formed with, a respective component which is part of the overall steering shaft assembly 56. Such parts may include a shaft extending from the steering wheel 42, an intermediate shaft, and a rack pinion, for example. However, these components are not limiting of the components which may be coupled to the hollow spider 102 with the yokes 104, 106. Irrespective of which precise components are coupled to the hollow spider 102, the universal joint assembly 100 allows the components to be operatively coupled to each other, while allowing different rotational degrees of freedom (i.e., about axes A and B).

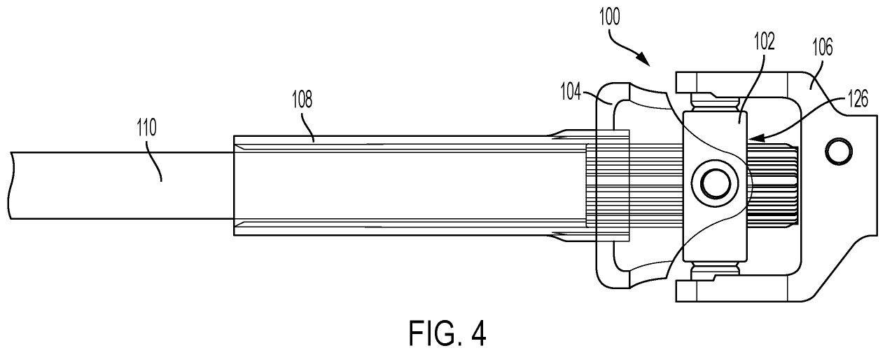

Referring now to FIG. 4, the universal joint assembly 100 is shown in an assembled condition, with the slider shaft 110 included to illustrate a benefit of the hollow spider 102. The slider shaft 110 is at least partially disposed within the shaft tube 108 and includes a splined portion 140 which is in splined engagement with a splined inner portion 142 (FIGS. 2 and 3) of the shaft tube 108. The splined connection between the slider shaft 110 and the shaft tube 108 allows a rotational torque to be transmitted from one to the other and vice versa, such that the slider shaft 110 and the shaft tube 108 rotate in a corresponding manner with each other. The rotational motion of these components is transferred to (or from) the first yoke 104 which is operatively coupled to the shaft tube 108. In the illustrated embodiment of FIGS. 2-4, the shaft tube 108 and the first yoke 104 are separate components which are operatively coupled to each other. Coupling may be made in any suitable manner, including by press fitting and staking or welding, for example. This connection allows the rotational torque to be transmitted to (or from) the second yoke 106, as well as any component connected to the second yoke 106.

As shown in FIG. 4, the slider shaft 110 is able to be translated through the central opening 126 of the hollow spider 102. This allows the slider shaft 110 to move significantly further when compared to a spider joint that does not include a central opening, or one large enough to allow the slider shaft 110 to fully pass through the spider 102. This is particularly beneficial for a steering shaft assembly requiring a large collapse distance.

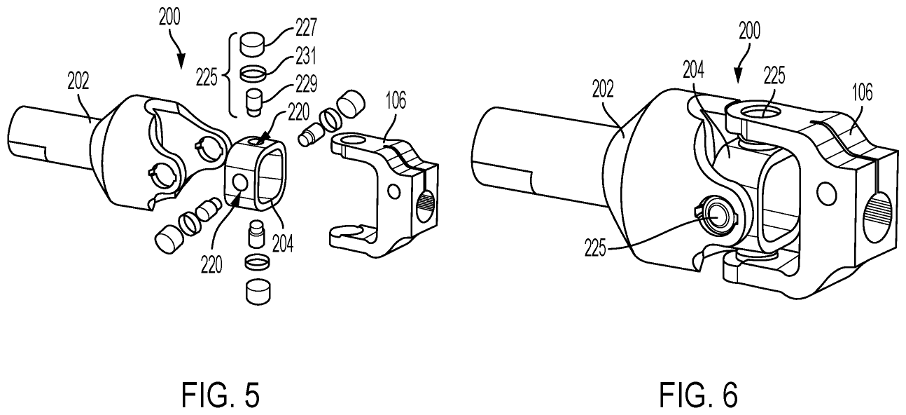

Referring now to FIGS. 5 and 6, another embodiment of the universal joint assembly is shown and is referenced generally with numeral 200. The universal joint assembly 200 is identical—or nearly identical—to the universal joint assembly 100 described in connection with FIGS. 2-4, but includes an integrally formed first yoke and shaft tube which is referenced with numeral 202. The integrally formed first yoke and shaft tube 202 is a single, monolithically formed component. A hollow spider is identical to the hollow spider 102 of FIGS. 2-4, but is referenced with numeral 204 in FIG. 5. The description of hollow spider 204 is not duplicated here.

The hollow spider 204 is structured to define the holes identical to holes 120 of the hollow spider 102, but are referenced with numeral 220 in FIG. 5. As with the holes of FIG. 2-4, holes 220 are sized and positioned to have a portion of a bearing assembly 225 disposed therein. The components of the bearing assembly 225 (i.e., a bearing 227, a pin 229 and a seal 231) and assembly process is described above in connection with FIGS. 2-4 and is not duplicated here.

The dimensions and geometry of the central opening 126 are customized to accommodate the diameter of the slider shaft 110 and to meet the joint angle requirements of the pivotable components attached to the hollow spider 102.

The embodiments disclosed herein maximize the collapse distance for a sliding shaft attached to a universal joint, while avoiding drastic reconfiguration of the overall spider. The universal joint assembly 100, 200 can be used in multiple sliding shaft configurations to accommodate performance requirements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A universal joint assembly for a steering shaft assembly comprising:
a first yoke;
a second yoke;
a hollow spider defining a central opening extending from a first end to a second end, wherein the first yoke is operatively coupled to the hollow spider and positioned on the first end of the hollow spider, the second yoke operatively coupled to the hollow spider and positioned on the second end of the hollow spider; and
a slider shaft extending through the first yoke and aligned with the central opening of the hollow spider, wherein the slider shaft is selectively translated through the central opening.

2. The universal joint assembly of claim 1, further comprising a shaft tube coupled to the slider shaft and to the first yoke, wherein the slider shaft, the shaft tube and the first yoke are rotationally coupled to each other.

3. The universal joint assembly of claim 2, wherein the shaft tube and the first yoke are integrally formed as a single, monolithically formed component.

4. The universal joint assembly of claim 2, wherein the shaft tube and the first yoke are separate components operatively coupled to each other.

5. The universal joint assembly of claim 4, wherein the shaft tube and the first yoke are welded to each other.

6. The universal joint assembly of claim 4, wherein the shaft tube and the first yoke are press fit and staked to each other.

7. The universal joint assembly of claim 2, wherein the slider shaft includes a splined portion engaged with a splined inner portion of the shaft tube to rotationally couple the slider shaft and the shaft tube to each other.

8. The universal joint assembly of claim 1, wherein the first yoke is operatively coupled to a first pair of opposite sides of the hollow spider and the second yoke is operatively coupled to a second pair of opposite sides of the hollow spider.

9. The universal joint assembly of claim 8, wherein the hollow spider has a rectangular cross-section.

10. The universal joint assembly of claim 8, wherein the first yoke and the second yoke are operatively coupled to the hollow spider with a plurality of bearing assemblies operatively coupled to the hollow spider.

11. A hollow spider for a universal joint assembly in a steering shaft assembly comprising:
a first side, a second side, a third side and a fourth side;
a first axial end and a second axial end;
an outer surface;
an inner surface defining a central opening sized to receive a shaft therethrough.

12. The hollow spider of claim 11, wherein the first side, the second side, the third side and the fourth side form a rectangular spider.

13. The hollow spider of claim 12, wherein the first side, the second side, the third side and the fourth side are joined by respective rounded corners.

14. A steering shaft assembly for a vehicle steering system comprising:
a first yoke;
a first shaft assembly component operatively coupled to the first yoke;
a second yoke;
a second shaft assembly component operatively coupled to the second yoke; and
a hollow spider defining a central opening extending from a first end to a second end, wherein the first yoke is operatively coupled to the hollow spider and positioned on the first end of the hollow spider, the second yoke operatively coupled to the hollow spider and positioned on the second end of the hollow spider,
wherein the first shaft assembly component extends through the first yoke and is aligned with the central opening of the hollow spider, wherein the first shaft assembly component is selectively translated through the central opening.

15. The steering shaft assembly of claim 14, wherein the first shaft assembly component is one of a handwheel shaft, an intermediate shaft and a rack pinion.

16. The steering shaft assembly of claim 14, further comprising a shaft tube coupled to the first shaft assembly component and to the first yoke, wherein the first shaft assembly component, the shaft tube and the first yoke are rotationally coupled to each other.

17. The steering shaft assembly of claim 16, wherein the shaft tube and the first yoke are integrally formed as a single, monolithically formed component.

18. The steering shaft assembly of claim 16, wherein the shaft tube and the first yoke are separate components operatively coupled to each other.
